(19) United States
(12) Patent Application Publication
(10) Pub. No.: US 2014/0021267 A1
(43) Pub. Date: Jan. 23, 2014

(54) SYSTEM AND METHOD FOR CROP THINNING WITH FERTILIZER

(71) Applicant: VISION ROBOTICS CORPORATION, San Diego, CA (US)

(72) Inventors: Mike SUDDUTH, Brawley, CA (US); Mike COSTA, Salinas, CA (US); Bret WALLACH, San Diego, CA (US); Claude BROWN, Lodi, CA (US)

(73) Assignee: VISION ROBOTICS CORPORATION, San Diego, CA (US)

(21) Appl. No.: 13/949,001

(22) Filed: Jul. 23, 2013

Related U.S. Application Data
(60) Provisional application No. 61/674,825, filed on Jul. 23, 2012.

(51) Int. Cl. A01C 23/00

(52) U.S. Cl. CPC A01C 23/007
USPC 239/1; 239/69

(57) ABSTRACT

Utilizes machine vision to thin fields, for example by selectively spraying plants with enough fertilizer to kill the plants, for example to maintain a minimum distance between plants or to enable remaining plants to grow in a pattern, for example two dimension diamond pattern. The use of fertilizer to kill plants has the benefit of fertilizing the field, i.e., the remaining plants not to be killed, at the same time. This unexpected result which occurs in the thinning and simultaneous fertilizing of a field is based the discovery that immature plants are more sensitive to fertilizer than mature plants. The system and method eliminates the need for harmful chemicals and mechanical thinners and may be retrofitted onto existing spray systems and platforms, thus eliminating herbicides and thinning machinery.

This application claims the benefit of U.S. Provisional Patent Application 61/674,825, filed on 23 Jul. 2012, the specification of which is hereby incorporated herein by reference.

### BACKGROUND OF THE INVENTION

1. Field of the Invention

One or more embodiments of the invention are related to the field of agricultural machinery for selectively removing or thinning plants with fertilizer using machine vision and robotics. More particularly, but not by way of limitation, one or more embodiments of the invention enable a system and method for crop thinning with fertilizer.

2. Description of the Related Art

One method of agricultural thinning fields is to thin the plants that are too close together by hand. To decrease the cost of labor, machines have been constructed to mechanically thin fields, for example lettuce fields, using mechanically activated hoes and knifes. Other techniques for thinning fields include spraying chemicals on unwanted or too closely spaced plants. Many of the chemicals utilized are harmful to the environment and potentially to the consumers of the agricultural products that the chemicals are used upon.

Recent immigration laws have placed further constraints on the use of manual labor. In addition, labor costs have risen, making manual labor less and less attractive to farmers. In response, machine vision systems are being developed to selectively thin and/or weed fields with mechanical device or chemicals. This enables planting enough seeds to ensure that the desired agricultural products germinate to the desired amount per area, wherein excess seedlings are then thinned to enable the remaining properly spaced plants to grow in the best amount of space. This technique is utilized to maximize the yield, but know machines are complex and/or utilize herbicidal chemicals, which increases costs, and again is potentially harmful to the environment and/or consumers.

A system that could potentially thin a crop and fertilize with the same chemical would decrease overall costs since no machinery or chemicals would be required for the thinning process. For at least the limitations described above there is a need for a system and method for crop thinning with fertilizer.

### BRIEF SUMMARY OF THE INVENTION

One or more embodiments described in the specification are related to a system and method for crop thinning with fertilizer. Embodiments of the invention utilize machine vision to selectively spray plants with enough fertilizer to kill the plants. The use of fertilizer to kill plants has the benefit of fertilizing the field at the same time. This unexpected result which occurs in the thinning and simultaneous fertilizing of a field is based the discovery that immature plants are more sensitive to fertilizer than mature plants.

One or more embodiments of the system for crop thinning with fertilizer include a camera and a sprayer. The camera is configured to capture images from an agricultural field. The sprayer is configured to selectively spray fertilizer on the agricultural field. One or more embodiments may employ a computer that is mounted on or near the same camera and sprayer. Other embodiments may utilize a remote computer that wirelessly communicates with the camera and sprayer. In one or more embodiments, the computer is coupled with the camera and the sprayer and is configured to obtain an image from the camera, process the image to determine locations of plants in the image, determine a first set of locations of plants to spray with the fertilizer to kill the plants and to leave other plants in a second set of locations unsprayed to simultaneously thin the agricultural field and to fertilize the agricultural field, and spray said first set of locations and not said second set of locations.

Embodiments may include a platform on which the camera and the sprayer are mounted. Other embodiments may mount the camera and sprayer on existing machinery for example. Any other mounting of the camera and sprayer are in keeping with the spirit of the invention. For example, one or more embodiments may locally mount a computer to obtain images and control the sprayer, or may utilize a remotely located computer to do so. In remote computer embodiments, a wireless communications interface may be located locally with respect to the camera and sprayer. Any other architecture that thins using fertilizer that is traditionally not used to kill plants is in keeping with the spirit of the invention.

Embodiments of the invention may move the camera and sprayer using a tractor in the agricultural field. Alternatively, the camera and sprayer autonomously move in the agricultural field, for example coupled with an autonomous moving robot or other apparatus that can move through an agricultural field without being driven by a human for example.

One or more embodiments of the method include obtaining an image from a camera using a computer, processing the image with the computer to determine locations of plants in the image, determining a first set of locations of plants to spray with the fertilizer to kill the plants and to leave other plants in a second set of locations unsprayed to simultaneously thin the agricultural field and to fertilize the agricultural field, spraying the first set of locations and not the second set of locations. Embodiments of the invention may utilize any image processing algorithm known to determine where plants are in an image, including comparing colors or ranges of pixels to gray scale values for example that occur over a certain area or number of pixels to determine if a plant exists in a particular location. Embodiments of the invention may utilize any pattern including a predetermined distance between plants in a line, or to utilize a diamond pattern or any other pattern to maximize the amount of crop yield as desired. If plants in a particular first set of locations based on the distance or pattern exist, then they are sprayed and if not then they are not sprayed.

Embodiments of the method may include utilizing the camera and the sprayer on a platform and either controlling the camera and sprayer with a locally mounted computer or wirelessly with a remotely located computer or any combination thereof. Embodiments of the method include moving the camera and the sprayer with a tractor in the agricultural field or alternatively moving the camera and the sprayer in the agricultural field.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a system view of an embodiment of the invention.

FIG. 2 illustrates a flow chart of an embodiment of the method of the invention.

### DETAILED DESCRIPTION

A system and method for crop thinning with fertilizer will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

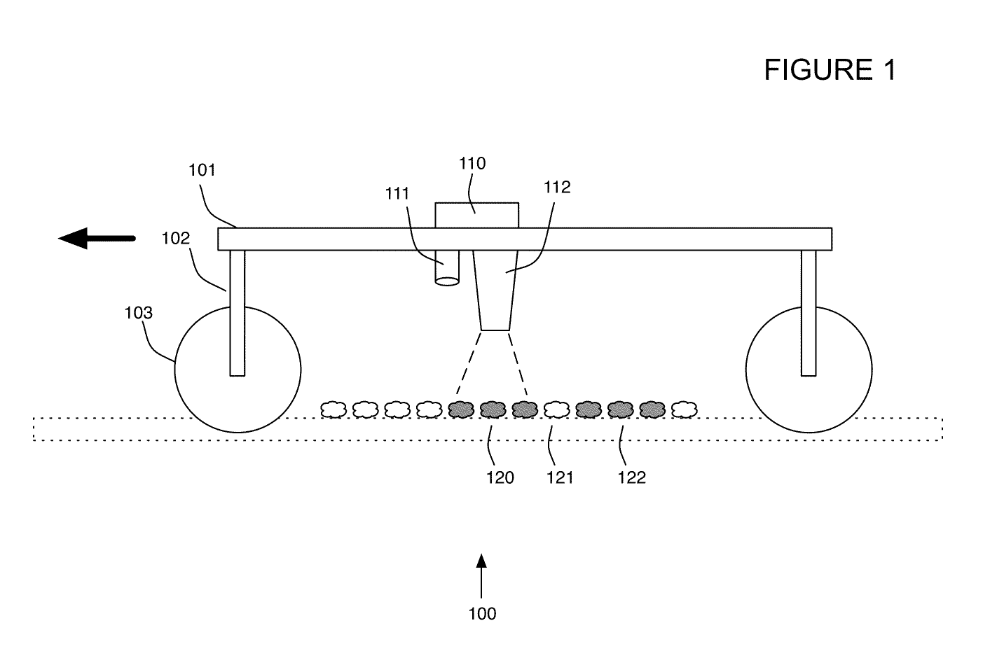

FIG. 1 illustrates a system view of an embodiment of the invention. Embodiments of the invention utilize machine vision to selectively spray plants with enough fertilizer to kill the plants. The use of fertilizer to kill plants has the benefit of fertilizing the field at the same time. This unexpected result which occurs in the thinning and simultaneous fertilizing of a field is based the discovery that immature plants are more sensitive to fertilizer than mature plants.

One or more embodiments of the system 100 for crop thinning with fertilizer include camera 111 and sprayer 112. Camera 111 is configured to capture images from an agricultural field, shown as a row a lettuce, e.g., 120, 121 and 122. Sprayer 112 is configured to selectively spray fertilizer on the agricultural field. One or more embodiments may employ computer 110 that is mounted on or near the same camera and sprayer, and for example coupled thereto electrically for example. Other embodiments may utilize a remote computer, not shown for brevity, that wirelessly communicates with the camera and sprayer, in which case element 110 may represent a wireless communications interface. In one or more embodiments, computer 110 is coupled with the camera and the sprayer and is configured to obtain an image from the camera, process the image to determine locations of plants in the image, determine a first set of locations of plants 120, 122 to spray with the fertilizer to kill the plants and to leave other plants in a second set of locations 121 unsprayed to simultaneously thin the agricultural field and to fertilize the agricultural field, and spray the first set of locations 120 and not the second set of locations 121 as the sprayer moves to the left in the figure. Alternatively, plant 121 may be fertilized with less fertilizer, for example under a particular threshold in order to provide plant 121 with enough fertilizer to grow but not kill plant 121.

Embodiments may include platform 101, for example having optional forks 102 and wheels 103, on which the camera and the sprayer are mounted. Other embodiments may mount the camera and sprayer on existing machinery for example, not shown for brevity. Any other mounting of the camera and sprayer are in keeping with the spirit of the invention. For example, one or more embodiments may locally mount a computer to obtain images and control the sprayer, or may utilize a remotely located computer to do so. In remote computer embodiments, a wireless communications interface may be located locally with respect to the camera and sprayer. Any other architecture that thins using fertilizer that is traditionally not used to kill plants is in keeping with the spirit of the invention.

Embodiments of the invention may move the camera and sprayer using a tractor in the agricultural field. Alternatively, the camera and sprayer autonomously move in the agricultural field, for example coupled with an autonomous moving robot or other apparatus that can move through an agricultural field without being driven by a human for example.

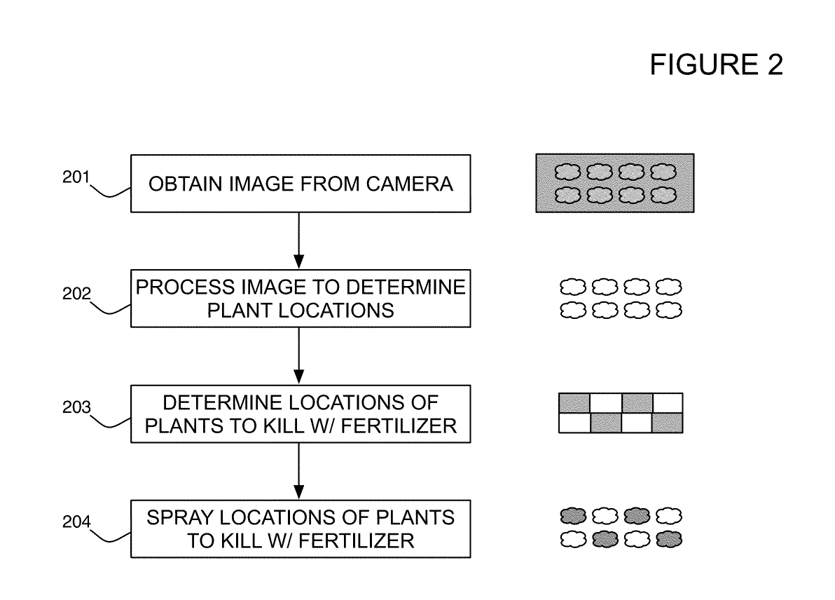

FIG. 2 illustrates a flow chart of an embodiment of the method of the invention. One or more embodiments of the method include obtaining an image from a camera using a computer at 201, processing the image with the computer at 202 to determine locations of plants in the image, determining a first set of locations of plants to spray with the fertilizer to kill the plants at 203 and to leave other plants in a second set of locations unsprayed or sprayed with an amount of fertilizer that will not kill the second set of locations of plants to simultaneously thin the agricultural field and to fertilize the agricultural field, and spraying the first set of locations and not the second set of locations at 204. Alternatively or in combination, step 203 may be implemented in one or more embodiments to determine a first set of locations of plants to spray with the fertilizer to kill the first set of locations of plants and determine a second set of locations of plants to not kill. Alternatively or in combination, step 204 may include not spraying plants that are not to be killed or spraying the plants not to be killed with fertilizer in a lesser amount than a particular level that would kill plants in order to fertilizer the plants that are not to be killed, while spraying the plants to kill with an amount of fertilizer sufficient to kill the designated plants. Step 204 may also be implemented in one or more embodiments as setting a first amount of fertilizer to spray the first set of locations of plants with that is sufficient to kill the first set of locations of plants and spraying the first set of locations of plants. This step may also including not spraying the second set of locations of plants or setting a second amount of fertilizer to spray the second set of locations of plants with that is sufficient to fertilize but not kill the second set of locations of plants and spraying the second set of locations of plants. Any combination of spraying to kill, spraying to fertilize and not spraying may also be utilized in one or more embodiments to selectively kill, fertilize or bypass operations on plants that for example are fertilized enough. For example, using spectral analysis, embodiments of the invention may determine that some plants not to kill may need fertilizer while others do not. Any method for determine how much fertilizer or whether or not to fertilize individual plants may be utilized with embodiments of the invention.

Shown to the right of the flow chart are the various images and patterns that correspond to the steps. Dark colored plants represent plants that have been sprayed with fertilizer to kill them. Light colored plants represent plants that have either not been sprayed, or sprayed with an amount of fertilizer that fertilizes the plants instead of killing them. Embodiments of the invention may utilize any image processing algorithm known to determine where plants are in an image, including comparing colors or ranges of pixels to gray scale values for example that occur over a certain area or number of pixels to determine if a plant exists in a particular location. Embodiments of the invention may utilize any pattern including a predetermined distance between plants in a line, or to utilize a diamond pattern or any other pattern to maximize the amount of crop yield as desired. If plants in a particular first set of locations based on the distance or pattern exist, then they are sprayed and if not then they are not sprayed.

Embodiments of the method may include utilizing the camera and the sprayer on a platform and either controlling the camera and sprayer with a locally mounted computer or wirelessly with a remotely located computer or any combination thereof. Embodiments of the method include moving the camera and the sprayer with a tractor in the agricultural field or alternatively moving the camera and the sprayer in the agricultural field.

While the invention herein disclosed has been described by means of specific embodiments and applications thereof, numerous modifications and variations could be made thereto by those skilled in the art without departing from the scope of the invention set forth in the claims.

Claims what is claimed is:

1. A system for crop thinning with fertilizer comprising:
a camera configured to capture images from an agricultural field;
a sprayer configured to selectively spray fertilizer on said agricultural field;
a computer coupled with said camera and said sprayer wherein said computer is configured to obtain an image from said camera;
process said image to determine locations of plants in said image;
determine a first set of locations of plants to spray with said fertilizer to kill said first set of locations of plants and determine a second set of locations of plants to not kill;
set a first amount of fertilizer to spray said first set of locations of plants with that is sufficient to kill said first set of locations of plants and spray said first set of locations of plants.

2. The system for crop thinning with fertilizer of claim 1 wherein said computer is further configured to
not spray said second set of locations of plants Or
set a second amount of fertilizer to spray said second set of locations of plants with that is sufficient to fertilize but not kill said second set of locations of plants and spray said second set of locations of plants.

3. The system for crop thinning with fertilizer of claim 1 further comprising a platform on which said camera and said sprayer are mounted.

4. The system for crop thinning with fertilizer of claim 1 further comprising a platform on which said camera and said sprayer are mounted and further comprises a wireless communications interface wherein said computer is located remote from said platform, said camera and said sprayer and wirelessly communicates with said camera and said sprayer.

5. The system for crop thinning with fertilizer of claim 1 further comprising a platform on which said computer is mounted.

6. The system for crop thinning with fertilizer of claim 1 wherein said camera and said sprayer are configured to be moved by a tractor in said agricultural field.

7. The system for crop thinning with fertilizer of claim 1 wherein said camera and said sprayer are configured to autonomously move in said agricultural field.

8. A method for crop thinning with fertilizer comprising:
obtaining an image from a camera using a computer;
processing said image with said computer to determine locations of plants in said image;
determining a first set of locations of plants to spray with said fertilizer to kill said first set of locations of plants and determine a second set of locations of plants to not kill;
setting a first amount of fertilizer to spray said first set of locations of plants with that is sufficient to kill said first set of locations of plants and spraying said first set of locations of plants.

9. The method for crop thinning with fertilizer of claim 8 further comprising.
not spraying said second set of locations of plants or
setting a second amount of fertilizer to spray said second set of locations of plants with that is sufficient to fertilize but not kill said second set of locations of plants and spraying said second set of locations of plants.

10. The method for crop thinning with fertilizer of claim 8 further comprising utilizing said camera and said sprayer on a platform.

11. The method for crop thinning with fertilizer of claim 8 further comprising utilizing said camera and said sprayer on a platform via a wireless communications interface wherein said computer is located remote from said platform, said camera and said sprayer and wirelessly communicates with said camera and said sprayer.

12. The method for crop thinning with fertilizer of claim 8 further comprising utilizing said camera and said sprayer on a platform using said computer on said platform.

13. The method for crop thinning with fertilizer of claim 8 moving said camera and said sprayer with a tractor in said agricultural field.

14. The method for crop thinning with fertilizer of claim 8 moving said camera and said sprayer autonomously in said agricultural field.
